(19) United States
(12) Patent Application Publication
(10) Pub. No.: US 2007/0126832 A1
(43) Pub. Date: Jun. 7, 2007

(54) Image recording apparatus

(75) Inventor: Eiichi Kito, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/634,098

(22) Filed: Dec. 6, 2006

(30) Foreign Application Priority Data
Dec. 6, 2005 (JP) 2005-351589

(51) Int. Cl. B41J 2/01

(52) U.S. Cl. 347/101

(57) ABSTRACT

The inkjet printer has a suction mechanism for sucking a recording medium in a printing table. The inkjet printer includes an opening/closing unit for closing a part of a plurality of suction holes provided in the suction mechanism. When a leading or trailing edge of the recording medium in a transport direction is printed, the opening/closing unit closes a part of the plurality of suction holes that are provided in a vicinity of the leading or trailing edge of the recording medium and do not covered with the recording medium.

The entire contents of documents cited in this specification are incorporated herein by reference.

### BACKGROUND OF THE INVENTION

The present invention generally relates to an inkjet printer, and more particularly relates to an inkjet printer that is capable of receiving ink which is ejected toward outside of the edges of a recording medium during borderless printing, by providing an ink receiving section, and is capable of suppressing air disturbance that would otherwise occur near the edges of the recording medium due to changes in airflow patterns flowing into suction holes for sucking and transporting the recording medium.

In these years, the demand for borderless printing by inkjet printers is increasingly growing. One reason for this is that inkjet printers in general employ a simple process basically similar to dry printing process. In addition, with the progress of inkjet printing technology, the quality of images (image quality) produced by inkjet printers has been significantly improved, such that the images produced by inkjet printers are almost comparative in quality to the images produced using silver halide photographic materials, and the difference between them has become negligible.

Along with such trend, business inkjet printers are also increasingly used. For business inkjet printers, it is desirable to, prior to the image forming, cut a rolled long sheet into multiple cut sheets, each having a length corresponding to the image to be formed thereon, and then to perform printing (i.e., inkjet printing) onto each sheet, so as to reduce cost of the recording material, as well as to prevent wasting material that might be caused if unnecessary intermediate portions between images are cut and disposed of.

However, due to various problems which might occur if borderless printing is performed onto cut sheet type recording material by an inkjet printer, as will be described later, currently it is common to form a series of images onto a long rolled sheet and then cut the sheet into multiple sheets on an each image basis.

An inkjet printer of basic configuration, for example, includes a recording head which is disposed on a surface facing a recording surface of a recording medium and has a plurality of rows of nozzles for ejecting ink toward the recording medium, a platen for supporting the recording medium from below so as to maintain a distance between the recording head and the recording medium, means for controlling scanning and ink ejection of the recording head, and means for controlling transportation (i.e., auxiliary scanning) of the recording medium.

When performing borderless printing by an inkjet printer, there may be a case in which ink (hereinafter alternatively referred to as the discarded ink) ejected toward outside of the edges of a recording medium may attach to the surface of the platen of a printing unit, and then attach to the recording medium, causing the recording medium to be stained by the ink. In order to prevent this, it is common to provide the surface of the platen with an absorbing body or an opening for absorbing ink.

For example, JP 2004-106432 A proposes an inkjet recording apparatus that has openings for absorbing discarded ink. The openings, each having a certain width in a direction perpendicular to the transport direction of a recording medium, are distributed in a plurality of locations on the surface of a platen of a printing unit, while preventing any adverse effect on the transport of the recording medium. The openings are arranged in a zigzag (or staggered) manner along the transport direction of the recording medium.

Also, in order for stably retaining the recording medium during inkjet printing, the inkjet recording apparatus has retaining means disposed in the backside (inner surface) of the platen facing a recording head of the printing unit. The retaining means includes sucking means for producing a sucking force similar to, but softer than, the sucking force used for transporting the recording medium.

In the inkjet printer having sucking means disposed in the backside (inner surface) of the platen of the printing unit with the sucking means facing the recording head, a part of a plurality of suction holes formed on the sucking means, in other words, only few suction holes are actually closed by a contact with the recording medium, when printing is performed onto the vicinity of the leading or trailing edge of the recording medium, while the recording medium passes on the sucking means and printed.

Therefore, there is a problem in which, when the printer performs printing onto the vicinity of unclosed suction holes, that is, near the leading or trailing edge of the recording medium, air movement (airflow) is generated from the upper surface of the recording medium and the vicinity thereof toward the suction holes, which causes adverse effects on ink-landing accuracy, resulting in degraded printing quality.

As for the problem described above, a technique disclosed in JP 2004-216651 A may be referred. JP 2004-216651 A proposes an ink-jet printer that includes suction holes for generating a support force for supporting a roll type recording medium on a platen (support surface of the recording medium) facing the recording head of the inkjet printer, and airflow restricting means made of a movable plate for reducing at least one of the amount and the speed of the air flowing into the suction holes, generated in the vicinity of the leading edge of the recording medium.

### SUMMARY OF THE INVENTION

The technique disclosed in JP 2004-216651 A, in which a roll type recording medium is intended as the recording medium, provides a certain level of effect as long as a roll type recording medium is used, since only the image in the leading edge is influenced by such air flow. However, if a cut sheet type recording medium is used for recording, the technique does not provide a sufficient level of effect, since every leading and trailing edges of each cut sheet can be influenced by the above described air flow.

In particular, when borderless printing, in which images will be printed up to the leading and trailing edges, is performed onto a cut sheet type recording medium, the image quality in the leading and trailing edges is significantly degraded.

The present invention has been made in order to solve the problems described above and an object of the present invention is to provide an inkjet printer that is capable of inkjet printing while preventing deterioration of image quality in the leading and/or trailing edges of the recording medium due to air flow for sucking a recording medium, not only when performing borderless printing onto a roll sheet type recording medium-but also even if performing borderless printing onto a cut sheet type recording medium, that is, to provide an inkjet printer capable of preventing deterioration of image quality.

In order to attain the above-described object, the present invention provides an inkjet printer having a suction mechanism for sucking a recording medium in a printing table comprising: opening/closing means for closing a part of a plurality of suction holes provided in the suction mechanism, wherein, when a leading or trailing edge of the recording medium in a transport direction is printed, the opening/closing means closes a part of the plurality of suction holes that are provided in a vicinity of the leading or trailing edge of the recording medium and are not covered with the recording medium.

Preferably, the inkjet printer further comprises a width directional ink receiving section having staggered arrangement structure in which width directional ink receivers are arranged in a staggered manner in a width direction perpendicular to the transport direction of the recording medium, wherein the opening/closing means controls opening/closing of the suction holes in a unit of each row in the width direction.

Preferably, the inkjet printer further comprises a transport directional ink receiving section having transport directional ink receivers that overlap with the width directional ink receivers arranged in the staggered manner in at least one of an upstream side and a downstream side and that are arranged in parallel along the transport direction of the recording medium, wherein the opening/closing means controls opening/closing of the suction holes in a unit of each row in the width direction separated by the transport directional ink receivers.

It is preferable that the transport directional ink receiving section has the transport directional ink receivers that correspond to a width of the recording medium and that are disposed along the transport direction of the recording medium.

Preferably, the inkjet printer further comprises transport directional ink receivers that correspond to a width of the recording medium and are disposed in parallel along the transport direction of the recording medium.

Additionally, in order to attain the object described above, the present invention provides an inkjet printer, comprising: a printing table including a suction mechanism having plural suction holes for sucking a recording medium to attach the recording medium on a surface of the printing table; an inkjet recording head disposed on an opposite side of the printing table, for ejecting ink droplets on the recording medium attached on the surface of the printing table to print an image on the recording medium; and opening/closing means for opening or closing each of the plural suction holes provided on the suction mechanism, wherein, when a leading and/or trailing edge of the recording medium in a transport direction of the recording medium is printed, the opening/closing means opens the plural suction holes covered with the recording medium to suck the recording medium to attach the recording medium on the surface of the printing table and closes a part of the plural suction holes that are provided in a vicinity of the leading and/or trailing edge of the recording medium and are not covered with the recording medium.

Preferably, the inkjet printer further comprises an ink receiving section that receives the ink droplets ejected from the inkjet recording head and landed outside an edge of the recording medium.

It is preferable that the ink receiving section comprises a first ink receiving section in a width direction having staggered arrangement structure in which first ink receivers in the width direction that receive the ink droplets landed outside the leading and/or trailing edge of the recording medium in the transport direction are arranged in a staggered manner in the width direction perpendicular to the transport direction of the recording medium, the suction mechanism comprises in the transport direction plural rows of the suction holes that are aligned in the width direction, and the opening/closing means controls opening/closing of the suction holes of the suction mechanism in each row of the suction holes in the width direction.

It is preferable that the ink receiving section comprises a second ink receiving section in the transport direction having second ink receivers in the transport direction that overlap with the first ink receivers arranged in the staggered manner in at least one of an upstream side and a downstream side, that are arranged in parallel along the transport direction and that receive the ink droplets landed outside a side edge of the recording medium in the width direction, the plural rows of the suction holes of the suction mechanism in the width direction are separated by the second ink receivers in the transport direction, and the opening/closing means controls opening/closing of the suction holes in each row of the suction holes in the width direction separated by the second ink receivers.

It is preferable that the second ink receiving section in the transport direction comprises the second ink receivers in the transport direction that correspond to a width of the recording medium and are disposed along the transport direction of the recording medium.

It is preferable that the ink receiving section comprises a second ink receiving section in the transport direction having at least one pair of second ink receivers in the transport direction that overlap with the first ink receivers arranged in the staggered manner in at least one of an upstream side and a downstream side, that are arranged in parallel along the transport direction and that receives the ink droplets landed outside both side edges of the recording medium in the width direction, the plural rows of the suction holes of the suction mechanism in the width direction are separated by the second ink receivers in the transport direction, and the opening/closing means controls opening/closing of the suction holes in each row of the suction holes in the width direction separated by adjacent two second ink receivers.

Also, it is preferable that the second ink receiving section in the transport direction comprises plural pairs of the second ink receivers in the transport direction that correspond to plural widths of recording media and are disposed along the transport direction of the recording medium.

As described above, one embodiment of the present invention provides an inkjet printer that is capable of inkjet printing while preventing deterioration of image quality in the leading and trailing edges of the recording medium, even if performing borderless printing onto a cut sheet type recording medium.

### BRIEF DESCRIPTION OF THE DRAWINGS

In the accompanying drawings:

FIG. 1 is a schematic view of one embodiment of a printer (inkjet printer) according to one embodiment of the present invention;

FIG. 2 is a schematic cross sectional view illustrating detailed configuration of a recording unit which is a principal part of an image recording section of the printer according to the embodiment;

FIG. 3 is a plan view of a suction printing table in the recording unit shown in FIG. 2.

FIG. 4 is an explanatory plan view (I) of the suction printing table illustrating characteristic operations of the printer according to the embodiment.

FIG. 5 is an explanatory plan view (II) of the suction printing table illustrating characteristic operations of the printer according to the embodiment.

FIG. 6 is an explanatory plan view (III) of the suction printing table illustrating characteristic operations of the printer according to the embodiment.

FIG. 7 is an explanatory plan view (IV) of the suction printing table illustrating characteristic operations of the printer according to the embodiment; and

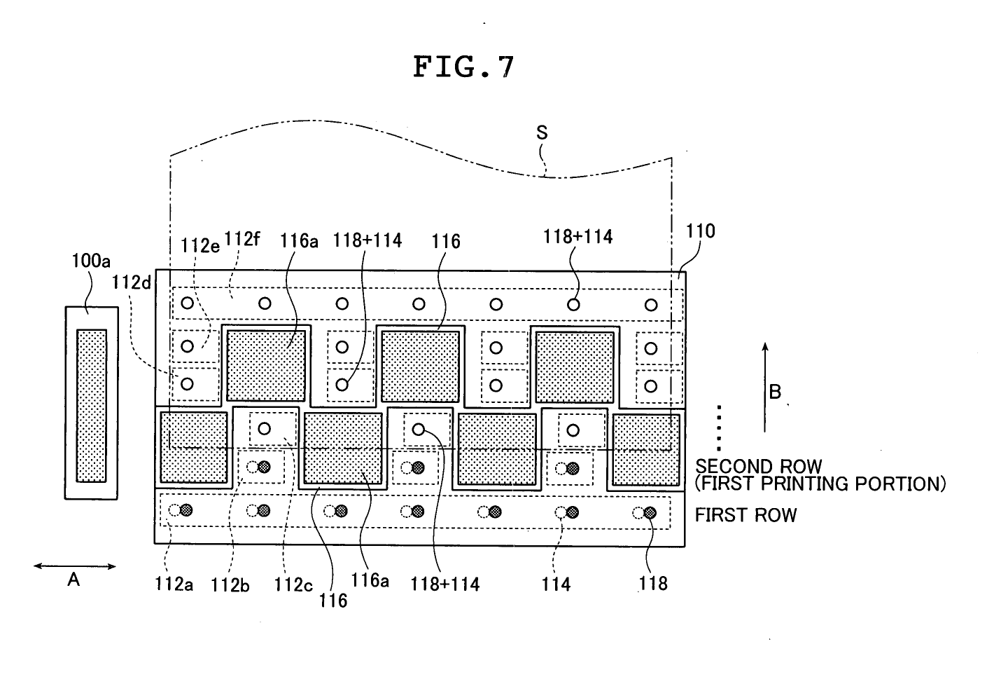

FIG. 8 is a plan view of a suction printing table according to another embodiment of the present invention.

### DETAILED DESCRIPTION OF THE INVENTION

An inkjet printer according to the present invention will hereinafter be described in detail on the basis of a preferred embodiment shown in the accompanying drawings.

The inkjet printer to be explained below is capable of inkjet printing onto roll sheet type recording medium as well as cut sheet type recording medium, as will be described later in detail. Further, as for the roll sheet type recording medium, printing mode can be selected so that printing is performed on the roll sheet type recording medium, either as it is, or after the roll sheet type recording medium is cut into multiple cut sheets.

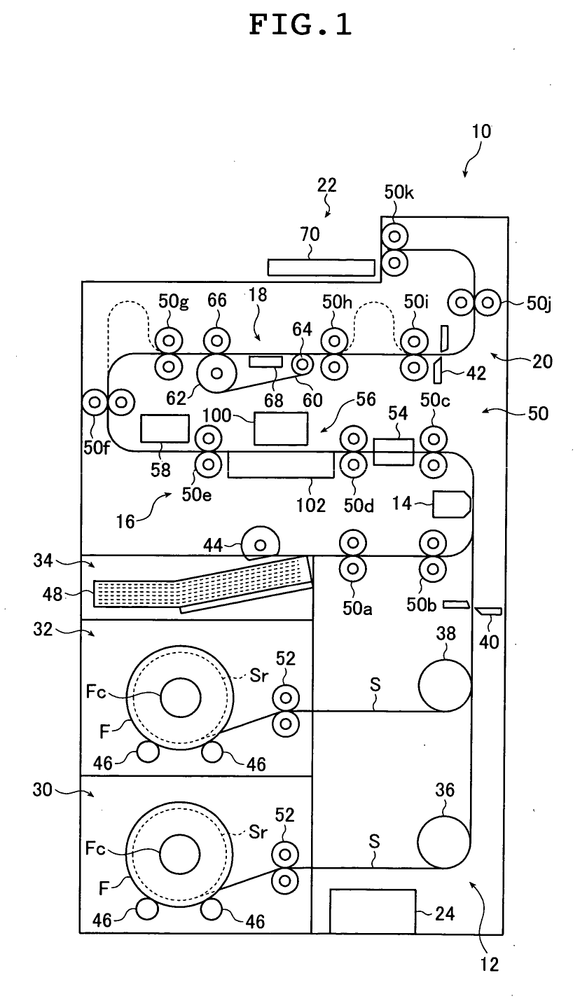

FIG. 1 shows a schematic view of an inkjet printer according to one embodiment of the present invention.

The inkjet printer (hereinafter simply referred to as the printer) 10 shown in FIG. 1, in order to generate a print, performs not only image recording by inkjetting onto a recording sheet S as the recording medium, but also performs backprinting or surface processing as needed, so that photography equivalent quality is achieved. The printer 10 basically includes a recording sheet feeding section 12, a backprinting unit 14, an image recording section 16, a surface processing section 18, a cutting section 20, and a discharging section 22.

Also, the printer 10 includes a control section 24 for controlling and managing entire operation of the printer 10, as well as for managing operation log histories of the printer 10.

It should be understood that the printer 10 may also include, in addition to those members shown in the drawings, a transport roller pair, a guide roller, a guide member, a sensor for detecting the recording sheet S, and other various members that are employed in known printers, as necessary.

The recording sheet feeding section 12 is a section for feeding the recording sheet S as the recording medium to the backprinting unit 14, and includes a first loading section 30, a second loading section 32, a cut sheet loading section 34, guide rollers 36, 38, a cutter 40, a sheet feeding roller 44, and two transport roller pairs 50 (50a, 50b).

The first loading section 30 and the second loading section 32 load a recording sheet roll Sr formed of a long recording sheet S rolled around a core member, and feed the recording sheet roll Sr to the backprinting unit 14 (and subsequent sections), through the cutter 40 which will be described later. If the recording sheet S has an ink receiving layer, the ink receiving layer is oriented outside when being rolled.

Since the first loading section 30 and the second loading section 32 are the same in structure, except that the location in the printer 10 is different, similar components are denoted by same reference numerals, and only the first loading section 30 will be described below as the representative.

The first loading section 30 (second loading section 32) has two flange rotating rollers 46 and a feed roller pair 52. The flange rotating rollers 46 are arranged in the transport direction with a predetermined space between them, and their rotating direction is aligned with the feeding direction of the recording sheet S (i.e., their axial direction is perpendicular to the document plane of FIG. 1).

The feed roller pair 52 is a known transport roller pair. The flange rotating rollers 46 and the feed roller pair 52 are both engaged to a known rotation driving source (not shown) through which the flange rotating rollers 46 and the feed roller pair 52 are driven to rotate in a forward (feeding) or backward (rewinding) direction.

In the printer 10 shown in the drawing, the recording sheet roll Sr is held (in the axial direction) by two disk-shaped flanges F having a cylinder portion Fc therebetween, which will be inserted in the core material. The flanges F are then mounted on the two flange rotating rollers 46 so that the recording sheet roll Sr is loaded in a predetermined position of the printer 10 (the first loading section 30 and the second loading section 32). The outer diameter of the flange F is greater than the maximum outer diameter of applicable recording sheet rolls Sr.

If printing is performed in a two-row parallel transport mode which will be described later, two recording sheet rolls Sr, while being held by the flanges F, are mounted on the flange rotating rollers 46 in the axial direction (perpendicular to the document plane of FIG. 1).

In the first loading section 30 (second loading section 32), the flange F is rotated by and synchronized with the flange rotating rollers 46, and the recording sheet S is transported by the feed roller 52 to allow the recording sheet S to be fed out from the recording sheet roll Sr. The flange F also serves as a guide member in feeding the recording sheet S.

It should be understood that in the practice of the present invention, the loading method of the recording sheet roll Sr is not limited to the above, and any other method available in various printers may be used. For example, a recording sheet roll Sr with its center being rotatably supported is housed in a magazine and the magazine is loaded to a predetermined loading position.

The recording sheet S of the recording sheet roll Sr which is loaded to the first loading section 30 is transported (fed) to the backprinting unit 14 through the cutter 40, then to the image recording section 16, while being guided by the guide roller 36. The recording sheet S of the recording sheet roll Sr which is loaded to the second loading section is conveyed to the backprinting unit 14 through the cutter 40, then to the image recording section 16, while being guided by the guide roller 38.

The cutter 40 may be a known Guillotine cutter. The cutter 40 may not be used for cutting the recording sheet S on an each print basis, rather, used for cutting the recording sheet S on an order basis, similar to shutting down the operation of the printer 10 in order to interrupt (abort) printing at a predetermined (preselected) timing.

In other words, in the printer 10 shown, when printing is performed onto the recording sheet S of the recording sheet roll Sr, backprinting is performed by the backprinting unit 14, image recording is performed by the image recording section 16, and surface treatment (if necessary) is performed by the surface processing section 18 onto the long recording sheet S as it is, and then the long recording sheet S is cut by the cutting section 20 to produce individual prints P.

Accordingly, when printing is performed using the recording sheet S of the recording sheet roll Sr, the recording sheet S is fed out from an active loading section of either the first loading section 30 or the second loading section 32 and transported along a predetermined route through the guide roller 36 or 38, and cutter 40, until its leading edge is positioned in a predetermined position (for example, a transport roller pair in the most upstream side of the image recording section 16), in a similar way as used in other known printers using a rolled recording medium (so called roll sheet).

If the recording sheet S is cut by the cutter 40, and if the remaining recording sheet S is not used in the subsequent printing, the flange rotating rollers 46 and the feed roller pair 52 are inversely rotated so that the recording sheet S is retracted to a predetermined position. In this case, the flange F also serves as a guide for guiding the recording sheet S to allow the recording sheet S to be rewinded appropriately toward the recording sheet roll Sr.

The cut sheet loading section 34 is a section for loading cut sheet type recording sheets S, which are produced by cutting the long recording sheet S into a plurality of sheets each having a predetermined size.

The cut sheet type recording sheets S are accommodated in a known cassette 48 as used in various printers, and the cassette 48 is loaded in a predetermined position of the cut sheet loading section 34, so that the cut sheet type recording sheets S are loaded in a predetermined position of the printer 10. In the embodiment shown in the drawings, if an ink receiving layer is provided, the cut sheet type recording sheets S are accommodated in the cassette 48 with the ink recording layer being oriented downward.

Each of the cut sheet type recording sheets S accommodated in the cassette 48 is then pulled out from the cassette 48 by the sheet feeding roller 44 which is a semilunar roller with a side peripheral surface cut into a plane shape. Then the cut sheet type recording sheet S is transported by the transport roller pairs 50a and 50b, and fed to the backprinting unit 14 by, such as, a not-shown guide.

In the printer 10 shown in the drawing, there is no limitation on the recording sheet S, and any known recording sheet S (image receiving sheet (image receiving medium)) may be used. For example, a plan paper sheet, an inkjet recording sheet with a matte or glossy surface having an ink receiving layer, an inkjet recording sheet (refer to JP 2005-35050 A) having an ink receiving layer made of thermal plastic resin particles and a layer for absorbing pigment ink solvent provided underneath the ink receiving layer, and an inkjet recording sheet for photographic image quality printing that has an ink-philic thermal plastic resin layer as an ink receiving layer may be used.

Examples of thermal plastic resin that may be used for inkjet recording sheet for photographic image quality printing include poly acrylic ester, polycarbonate, polyacrylonitrile, polystyrene, polybutadiene, poly (meth) acrylic acid, polyvinyl chloride, poly vinylidene chloride, polyvinyl acetate, polyester, polyamide, polyether, and copolymers thereof. Among the copolymers, poly acrylic ester copolymer, styrene-acrylic ester copolymer, polyvinyl chloride-acetic conolvmer, polyvinyl chloride-acrylic ester copolymer, ethylene-vinyl acetate copolymer, ethylene-acrylic ester copolymer, and SBR latex are preferably exemplified.

The printer 10 according to the present invention is not limited to those uses both the roll sheet and the cut sheet as described above, and only the roll sheet or only the cut sheet can be used.

In addition, if the roll sheet is used, the recording sheet S may be cut just after being pulled out from the recording sheet roll so that backprinting or image recording is performed on the cut sheet, instead of cutting the roll sheet into individual prints in the last stage.

The backprinting unit 14 performs backprinting on a back surface (or non image printing surface in the case of the recording sheet S having an ink receiving layer) of the recording sheet S by using such as a dot impact printer. Backprinting may also be performed by using an inkjet printer or a thermal printer.

There is no limitation on the content of the backprinting, and various types of information, which are standard in photographic printing, may be exemplified as the content of backprinting.

The image recording section 16 is a section for recording an image onto the long recording sheet S, or cut sheet type recording sheet S. The image recording section 16 includes, in the order from upstream side toward downstream side, a regulating guide 54, a recording unit 56 for recording an image onto the recording sheet S, and a drying means 58 for drying the recording sheet S on which an image is recorded. A transport roller pair 50c is arranged upstream of the regulating guide 54, a transport roller pair 50d is arranged between the regulating guide 54 and the recording unit 56, and a transport roller pair 50e is arranged between the recording unit 56 and the drying means 58, respectively.

The regulating guide 54 arranged upstream of the recording unit 56 (between the transport roller pair 50c and the transport roller pair 50d) regulates the recording sheet S with respect to positions in a direction (i.e., width direction) perpendicular to the transport direction of the recording sheet S fed to the recording unit 56 for recording an image by inkjet so that the recording sheet S is transported to a predetermined position.

The recording unit 56 arranged downstream of the regulating guide 54 (transport roller pair 50d) includes recording means 100 of known inkjetting using an inkjet recording head (hereinafter referred to as the recording head), and a reference guide 102 for regulating the recording sheet S with respect to positions in the horizontal direction. The recording unit 56 performs known image recording of a full color image by inkjetting.

The method of image recording (drawing) performed by the recording means 100 may be any known method used in inkjet printers, without any particular limitation.

For example, a method of image recording based on so called FWA (Full Width Array) technology may be used in the recording means 100, in which a line head having a nozzle array (an array Qf nozzles for ejecting ink droplets) which is longer than the maximum width of recording sheet S is used to sequentially transport (scan and transport) the recording sheet S to perform image recording.

A method of image recording based on so-called PWA (Partial Width Array) technology may also be used in the recording means 100, in which a small type of recording head is mounted on a carriage (scanning means) with its nozzle array aligned with the transport direction of the recording sheet S. The recording sheet S is intermittently transported, and while the transportation of the recording sheet S is stopped, image recording is performed through scanning by the recording head in the width direction.

Accordingly, if the recording means 100 performs image recording based on FWA technology, the transport roller pairs 50c-50e (and 50f which will be described later) transport the recording sheet S in a sequential manner, and if the recording means 100 performs image recording based on PWA technology, the transport roller pairs 50c-50e (and 50f which will be described later) transport the recording sheet S in an intermittent manner.

The reference guide 102, which will be described later in detail, has a suction hole in its upper surface (transport surface of the recording sheet S=position reference surface), so that lifting of the recording sheet S is prevented appropriately, for example, by sucking from inside, ensuring the recording sheet S to be regulated to a predetermined position, more reliably and accurately.

The reference guide 102 not only maintains the recording sheet S in a predetermined position, but also serves to transport the recording sheet S using a known transport means such as a belt conveyer. Moreover, the reference guide 102 may have an ink receiver of a groove shape for example, which is formed according to the width of applicable recording sheets S so as to prevent contamination with ink during so-called borderless printing in which image is recorded up to the edge of the print.

The drying means 58 is arranged downstream of the reference guide 102 (and the recording means 100).

The drying means 58 dries ink on the recording sheet S subjected to image recording by inkjetting. There is no limitation on the drying means 58, and any known means may be employed, such as, using a heater, or a fan, or using both heater and fan.

The transport roller pair 50e, which is disposed between the reference guide 102 and the drying means 58, is detachable, so that a space can be provided as necessary to prevent attachment of ink before being dried.

The recording sheet S that has been dried by the drying means 58, is then transported to the surface treatment section 18 by the transport roller pairs 50f and 50g. Between the transport roller pair 50f and the transport roller pair 50g, a loop forming portion for the recording sheet S is provided, which will also be described in detail later.

The surface treatment section 18 performs surface treatment on an ink receiving layer (thermal plastic resin), in the case where the inkjet recording sheet for photographic image quality printing having an ink receiving layer made of thermal plastic resin particles or ink-philic thermal plastic resin as described above, is used as the recording sheet S.

In the case where a recording sheet S other than those described above is used, surface treatment in the surface treatment section 18 is not necessary in general. Therefore, the recording sheet S is preferably transported toward downstream after no treatment is performed in the surface treatment section 18 by separating the nip roller 66 from a surface treatment belt 60.

It should be understood that even if a recording sheet S other than the inkjet recording sheet for photographic image quality printing is used, the recording sheet S can be subjected to surface treatment as needed, as will be described later.

The surface treatment section 18 uses the surface treatment belt 60 to perform surface treatment on the recording sheet S, in such a manner that the surface (ink receiving layer) of the recording sheet S is brought into contact with the surface of the, surface treatment belt 60, and pressed/heated, and then cooled.

In the embodiment shown in the drawing, the surface treatment section 18 includes in addition to the surface treatment belt 60, a heating roller 62, a roller 64, the nip roller 66, and a cooling section 68. The surface treatment belt 60, which is an endless belt, is stretched across the heating roller 62 and the roller 64.

The surface treatment belt 60 has a surface (outer surface) having an extremely high smoothness. The heating roller 62 is a known heating roller that emits heat of a temperature applicable to heating treatment of the recording sheet S. The cooling section 68 cools the surface treatment belt 60 by abutting it from its inside, to allow the recording sheet S which is transported by the surface treatment belt 60 to be cooled. The nip roller 66 abuts and presses the surface treatment belt 60 at a position corresponding to the heating roller 62, so as to press the recording sheet S against the surface treatment belt 60 and to nip and transport the recording sheet S along with the surface treatment belt 60.

There is no limitation on the heating means in the heating roller 62, as well as cooling means in the cooling section 68, and any known means can be used. The nip roller 66 may also have heating means.

As apparent from FIG. 1, the recording sheet S on which an image has been recorded by inkjetting is transported to the surface treatment section 18 with its image forming surface oriented toward the surface treatment belt 60.

In the surface treatment section 18, firstly, the recording sheet S is held and transported by the surface treatment belt 60 (heating roller 62) and the nip roller 66. Then the recording sheet S is heated by the heating roller 62, while the surface (ink receiving layer) of the recording sheet is abutted against the surface of the surface treatment belt 60.

Through the heating/pressing, the recording sheet S becomes slightly adhesive to the surface treatment belt 60 due to melt of the ink receiving layer made of a thermal plastic resin. The recording sheet S is transported by the surface treatment belt 60, while slightly adhering thereto. During the transportation, in the surface treatment section 18, the recording sheet S is cooled by the cooling section 68 to set the melted ink receiving layer.

The recording sheet S that has been cooled is separated from the surface treatment belt 60 at a fold back part of the roller 64 and then fed to the transport roller pair 50h in the downstream.

The ink receiving layer (thermal plastic resin) of the recording sheet S is thus pressed against the surface treatment belt 60 and heated/melted into an adhesive state. The ink receiving layer is then cooled/set so that the surface property of the surface treatment belt 60 is transferred to the ink receiving layer. As already described above, the surface treatment belt 60 has an extremely high surface smoothness. Therefore, the recording sheet S on which the surface property of the surface treatment belt 60 has been transferred will have a high surface smoothness and good glossiness, which allows production of a high quality print comparative to the silver halide photograph.

Moreover, the surface treatment of the recording sheet S allows not only imparting of glossiness, but also providing various other surface treatments such as matting (roughing), by selecting a desired surface property of the surface treatment belt 60.

The printer 10 may have a function for controlling the heating condition and/or cooling condition in the surface treatment section 18 so as to control the glossiness to be imparted to the surface of the recording sheet S (print).

Moreover, in the embodiment shown in the drawings, stiffness inherent in the recording sheet S is utilized to separate the recording sheet S from the surface treatment belt 60. Therefore, if reducing the diameter of the roller 64 that stretches the surface treatment belt 60 at a position where the recording sheet S is discharged from the surface treatment section 18 as shown in FIG. 1, the separation property in separating the recording sheet S from the surface treatment belt 60 can be improved.

The recording sheet S that has been subjected to surface treatment in the surface treatment section 18, or has passed through the surface treatment section 18 is then transported to the cutting section 20 by the transport roller pair 50h and 50i. Between the transport roller pair 50h and transport roller pair 50i, a loop forming portion for the recording sheet is provided, which will also be described in detail later.

The cutting section 20 uses a cutter 42 of a known Guillotine cutter to cut, in the width direction, a long recording sheet S that has been supplied from the first loading section 30 or the second loading section 32, recorded an image by inkjetting in the image recording section 16, and, if necessary, subjected to surface treatment in the surface treatment section 18, so that individual prints are obtained (the recording sheet is cut into prints one by one).

It should be noted that the cutting section 20 of the printer 10 is not limited to cutting a long recording sheet S (rolled sheet). The cutting section 20 may be used, for example, in the case where a cut sheet type recording sheet S supplied from the cut sheet loading section 34 is used, to cut the leading/trailing edge (in the transport direction) of the cut sheet type recording sheet S in order to adjust the size for outputting, or to cut the leading/trailing edge of a so-called borderless print in which an image is recorded up to the edges.

While, in the printer 10 shown in the drawings, the cutting section 20 includes only the cutter 42 to cut the recording sheet S in the width direction, the present invention is not limited to this.

For example, if the recording unit 56 performs a so-called multi-imposition printing in the width direction, in which two or more images are recorded in the width direction, cutting means such as a slitter may be provided in the cutting section 20 to cut the recording sheet S in the transport direction.

As described above, each loop forming portion for forming a loop of the recording sheet S (a slack in the recording sheet S) is provided between the transport roller pair 50f and the transport roller pair 50g, where the recording sheet S is transported from the image recording section 16 to the surface treatment section 18, and between the transport roller pair 50h and the transport roller pair 50i, where the recording sheet S is transported from the surface treatment section 18 to the cutting section 20.

The surface treatment section 18 performs surface treatment by heating/melting the ink receiving layer of the recording sheet S and transporting/cooling the recording sheet S with the recording sheet S slightly adhering to the surface treatment belt 60.

Therefore, in the surface treatment section 18, if the transport of the recording sheet S is stopped, over-heating or over-cooling may occur to cause unevenness in the surface treatment, resulting in uneven glossiness. For this reason, the transport of the recording sheet S is not allowed to stop during the process in the surface treatment section 18.

Also, if load fluctuation occurs during the treatment in the surface treatment section 18, for example, in the event the recording sheet S is forcedly pushed into the surface treatment section 18, or pulled from the surface treatment section 18, the recording sheet S to be adhered to the surface treatment belt 60 can be out of sync with the belt, which also causes uneven glossiness.

However, if the recording means 100 performs image recording based on PWA technology, the recording sheet S is transported in an intermittent manner. Also, even if the recording means 100 performs image recording based on FWA technology, the transport speed (scan transport speed) corresponding to the image recording by the recording means 100 may be different from the transport speed corresponding to the surface treatment by the surface treatment section 18.

On the other hand, since the cutting section 20 uses Guillotine cutter 42, it is necessary to stop the transport of the recording sheet S, when cutting.

Accordingly, in the printer 10, when a print is produced using a long recording sheet S (rolled sheet) supplied from the first loading section 30 or the second loading section 32, the edge of the recording sheet S is stopped by the transport roller pair 50g, without stopping the recording sheet S in the surface treatment section 18. After a loop of the recording sheet S of a length sufficient to prevent any load fluctuation on the transport of the recording sheet S in the surface treatment section 18 is formed between the transport roller pairs 50f and 50g, the transport by the roller pair 50g is started to transport the recording sheet S to the surface treatment section 18.

Also, when a print is produced using a long recording sheet S, similarly to the above, the edge of the recording sheet S is stopped by the transport roller pair 50i, without stopping the recording sheet S in the surface treatment section 18. After a loop of the recording sheet S of a length sufficient to prevent any load fluctuation on the transport of the recording sheet S in the surface treatment section 18 is formed between the transport roller pairs 50i and 50h, the transport by the roller pair 50i is started to transport the recording sheet S to the cutting section 20 (Guillotine cutter 42).

The transport speed of the transport roller pairs 50g and 50h is controlled to synchronize to the transport speed of the recording sheet in the surface treatment section 18 so as to prevent any load fluctuation on the transport of the recording sheet in the surface treatment section 18.

The transport by the transport roller pairs 50i and 50g may be performed in an intermittent manner so as to correspond to the operation of the Guillotine cutter 42.

The recording sheet S, i.e., the print, which has been cut by the cutting section 20 (Guillotine cutter 42) is discharged by the transport roller pairs 50j and 50k to the discharging section 22.

The discharging section 22 uses an orthogonal transport belt (belt conveyor) 70 traveling in the depth direction in the document surface of FIG. 1, to sort the prints on an each order basis. The prints are discharged by the transport roller pair 50k onto the orthogonal transport belt 70 of the discharging section 22, and stacked thereon. When the prints for one order are stacked, the stacked prints are transported by the orthogonal transport belt 70 by a distance corresponding to the size of one print (a length in the width direction) in the depth, direction so that a portion of the belt on which no prints are stacked will be used as a discharge position from the transport roller pair 50k. The orthogonal transport belt 70 repeats the stacking/transporting so that the prints are sorted on an each order basis.

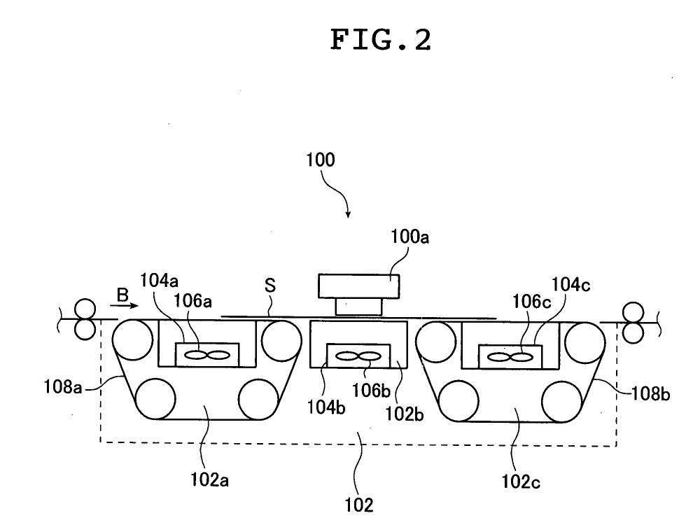

FIG. 2 illustrates a detailed configuration of the recording unit 56 that serves as a main part of the image recording section 16 of the printer 10 according to this embodiment. Referring to FIG. 2, a specific configuration of the recording means 100 based on known inkjetting and the reference guide 102 that regulates the recording sheet S with respect to the vertical position, while the recording sheet S is transported in the direction indicated by Arrow B, will be described.

In the embodiment shown in FIG. 2, as the recording means 100, an image recording apparatus based on the above described PWA technology is used. However, it is shown as an example, and of course an image recording apparatus based on FWA technology may also be used.

As shown in FIG. 2, the recording means 100 of the printer 10 according to the embodiment includes a recording head 100a and a suction printing table 102b (specific description will be given in conjunction with the description of the reference guide 102) arranged opposing to the recording head 100a.

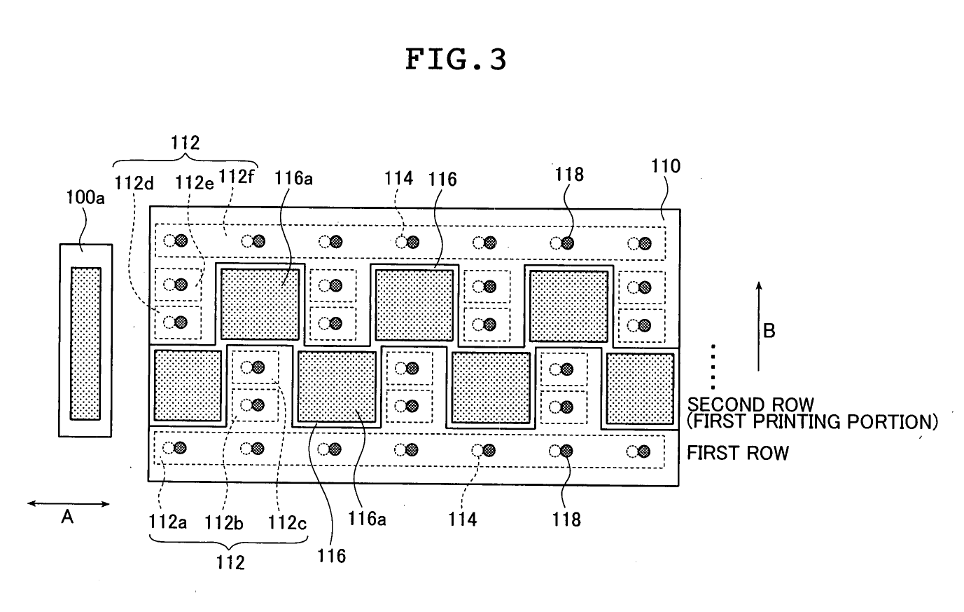

The recording head 100a, which is based on PWA technology in the example, as described, performs inkjet recording onto the recording sheet S, through a reciprocating motion in the direction (direction perpendicular to the recording sheet transport direction B) indicated by Arrow A in FIG. 3 in which a plane view of the suction printing table 102b is shown.

The recording head 100a is capable of ejecting ink, through not-shown control means, in such a manner that the ink lands only on a desired region in the recording sheet transport direction (in other words, the recording head 100a is controlled by the not-shown control means so that only a desired region is printed, as necessary). As will be described later, such capability is useful in performing borderless printing onto a sheet type recording sheet S, because the printing region can be changed depending on the portion in the recording sheet S, such as, the leading edge, the trailing edge, or the intermediate portion in order to perform borderless printing efficiently.

Specifically, in performing borderless printing onto the leading and trailing edges of the recording sheet S, the recording head 100a determines the width of the area to which print is performed and controls whether or not the ink is ejected on each position in the width direction of the recording sheet S corresponding to the position (dimension, refer to FIG. 3) of the ink receivers arranged in a staggered manner.

The reference guide 102 also includes, a front suction transport section 102a, the suction printing table 102b, and a rear suction transport section 102c, arranged in this order, from the upstream side to the downstream side in the transport direction of the recording sheet S, as shown in FIG. 2.

The reference guide 102 has a function for transporting the recording sheet S in a desired direction by using the two suction transport sections of the front suction transport section 102a and the rear suction transport section 102c, and a function for regulating the recording sheet with respect to the vertical position, during the transport of the recording sheet S, through the suction printing table 102b.

The suction printing table 102b, and the suction transport sections 102a, 102c, have suction boxes 104b, 104a, 104c respectively. A plurality of suction holes 118 (refer to FIG. 3) are provided on the front surface (upper surface), of each of suction boxes 104b, 104a, 104c. Suction fans 106b, 106a, 106c are provided inside of the suction boxes 104b, 104a, 104c respectively. Also, each of the suction transport sections 102a, 102c, includes an air permeable transport belt of endless type arranged around each of the suction boxes 104a, 104c, and a transport mechanism 108a, 108c having a plurality of rollers for rotatably driving the air permeable transport belt.

In the both of the front suction transport section 102a and the rear suction transport section 102c, a function for regulating the recording sheet S with respect to the vertical position, in particular the recording-sheet S on the front (upper) surface of the suction printing table 102b, is achieved by the suction boxes 104a, 104c, the suction fans 106a, 106c, and the suction holes 118.

In a manner as described above, through the both of the front suction transport section 102a, and the rear suction transport section 102c, the function for transporting the recording sheet S, and the function for regulating the recording sheet S on the front (upper) surface of the suction printing table 102b with respect to the vertical position are achieved.

Referring now to the plane view shown in FIG. 3, the Configuration of the above described sections will be described in detail by using the suction printing table 102b as the representative. It should be noted that, the both of the front suction transport section 102a, and the rear suction transport section 102c can be considered the same in configuration as the suction printing table 102b, except that a function to open/close the suction holes is not included in the front suction transport section 102a, and the rear suction transport section 102c.

As shown in FIG. 3, a plurality of suction holes 118 are provided over the substantially entire surface of an upper surface (hereinafter referred to as the platen 110) of the suction printing table 102b (as well as the front suction transport section 102a and the rear suction transport section 102c). The suction transport sections 102a, 102c transport the recording sheet S in a predetermined direction by the transport mechanisms 108a, 108c, arranged around the suction boxes 104a, 104c, in which the suction fans 106a, 106c are provided respectively.

In the platen 110 on the suction printing table 102b, the recording sheet S is suctioned and transported by the suction transport sections 102a, 102c. While the recording sheet S is transported, it is also suctioned and aligned to the platen 110, where printing (inkjet printing) is performed on the recording sheet S by ink droplets ejected, in a controlled manner, from the recording head 100a disposed above the suction printing table 102b.

In FIG. 3, reference numeric 116 denotes an ink receiver (similar, in basic configuration, to the ink receiver shown in JP 2004-106432A which includes ink absorbers arranged in a staggered manner) provided for collecting ink droplets landed outside of the leading edge or trailing edge of the recording sheet S in order to avoid the ink droplets from contaminating the recording sheet S (print). The ink receiver 116 is formed of a rectangular concave provided on a suction printing table 102b Splaten 110) in which an ink absorber 116a is put and arranged in an intermittent (staggered) manner, with a predetermined pitch provided in both the transport direction of the recording sheet S and the direction perpendicular to the transport direction. A plurality of ink receivers 116, seven ink receivers 116 in the drawing, arranged in a staggered manner in the width direction of the recording sheet S form an ink receiving section, particularly, an ink receiving section in the width direction. Here, in the drawing, all the ink receivers 116 arranged in a staggered manner are connected together, and the ink received by these ink receivers 116 is recovered into an ink reservoir not shown in the drawing.

In a case of borderless printing, if some of the plurality of suction holes 118 are not abutted by the recording sheet S and are remained unclosed, air movement (airflow) occurs around the unclosed suction holes 118, in other words, in the vicinity of the leading or trailing edge of the recording sheet S. The airflow, which moves from the area including the top surface of the recording sheet S toward the suction hole 118, may affect the ejection status of the ink droplets for printing the top surface of the recording sheet S, resulting in degraded image quality.

In the printer 10 according to this embodiment, in order to prevent such a problem, measures are taken as described below. That is, as illustrated in FIG. 3 and the subsequent drawings, airflow shielding plates 112 (112a-112f, six rows of airflow shielding plates are shown in the drawing) each having a predetermined number of through holes 114 for passing suction airflow are provided along the direction (main-scan direction: horizontal direction in the drawing) perpendicular to the transport direction (sub-scan direction: vertical direction in the drawing) of the recording sheet S. The arrangement pitch and the diameter of the through holes 114 are the same or substantially the same as the suction holes 118 of the suction printing table 102b (platen 110). The airflow shielding plates 112a-112f are operated in sync with the transport of the recording sheet S. Locations where the airflow shielding plates 112 (112a-112f) are provided are not particularly limited as long as the suction holes 118 on the suction printing table 102 (platen 110) are allowed to open and close. The airflow shielding plates 112 may be provided on the upper surface of the platen 110 or within the suction printing table 102b, for instance.

The airflow shielding plates 112a-112f, as shown in FIG. 3, are arranged in such a manner that a certain distance is kept from the ink receivers 116 that are arranged on the platen 110 (some ink receivers may be arranged in a split shape where necessary). The airflow shielding plates 112a-112f have through holes 114 arranged in the same pitch as the suction hole 118 provided on the platen 110. The airflow shielding slates 112a-112f are configured to move back and force between two positions in the horizontal direction in FIG. 3, that is, a position where the through hole 114 overlaps with the suction hole 118 provided on the platen 110 (the suction of the recording sheet S is enabled) and a position where those holes do not overlap with each other (the suction of the recording sheet S is disabled).

For simplicity of description, the airflow shielding plates 112 are given reference numerals 112a-112f, from the lower side in the drawings towards the upper side in the drawing. In addition, the portions corresponding to the airflow shielding plates 112b-112e will be referred to as the first printing portion, second printing portion, third printing portion, and fourth printing portion, respectively.

Such designations are given because the recording head 100a is capable of controlling the ink ejecting region (width) based on a length of substantially one quarter of the total length of the recording sheet S in the transport direction.

More specifically, the airflow shielding plates 112a-112f allow the through holes 114 (represented by doted line open circles (◯)) provided on the airflow shielding plates 112a-112f to move with respect to the suction holes 118 (represented by a solid line filled circles(●)) provided on the platen 110. For example, the through holes 114 are moved slightly to the right, that is, from the position in which the through holes 114 and the suction holes 118 are not overlapped (the suction of the recording paper S is disabled) as shown in FIG. 3, to the position in which the through holes 114 and the suction holes 118 are overlapped (the suction of the recording paper S is enabled). Inversely the through holes 114 may be moved slightly to the left, so that the status can be changed from the status in which those two holes are overlapped to the status in which those two holes are not overlapped.

As will be described later in detail, such movement of the airflow shielding plates 112a-112f can be controlled on an each row of the suction holes 118 provided on the platen 110 basis, in order to suitably accommodate positional changes of the recording sheet S as being transported on the platen 110.

Opening/closing operation of the suction holes 118 performed on an each row basis by moving the airflow shielding plates 112a-112f, as described above, may be achieved by using a not-shown sensor to detect the leading/trailing edge position of the recording sheet S being transported by the transport mechanism 108a provided in the front suction transport section 102a, for example.

The operation of the airflow shielding plates 112a-112f will be described, based on each position where the recording sheet S reaches during transportation. While the following description explains an example in which the recording sheet S is intermittently driven in a pitch equal to the set pitch of the suction hole 118 provided on the platen 110, and in order to correspond to the pitch, the recording head 100a is configured to control the ink ejecting region (width) based on a length of substantially one quarter of the length of the recording head 100a in the recording sheet transport direction, other configurations may also be used.

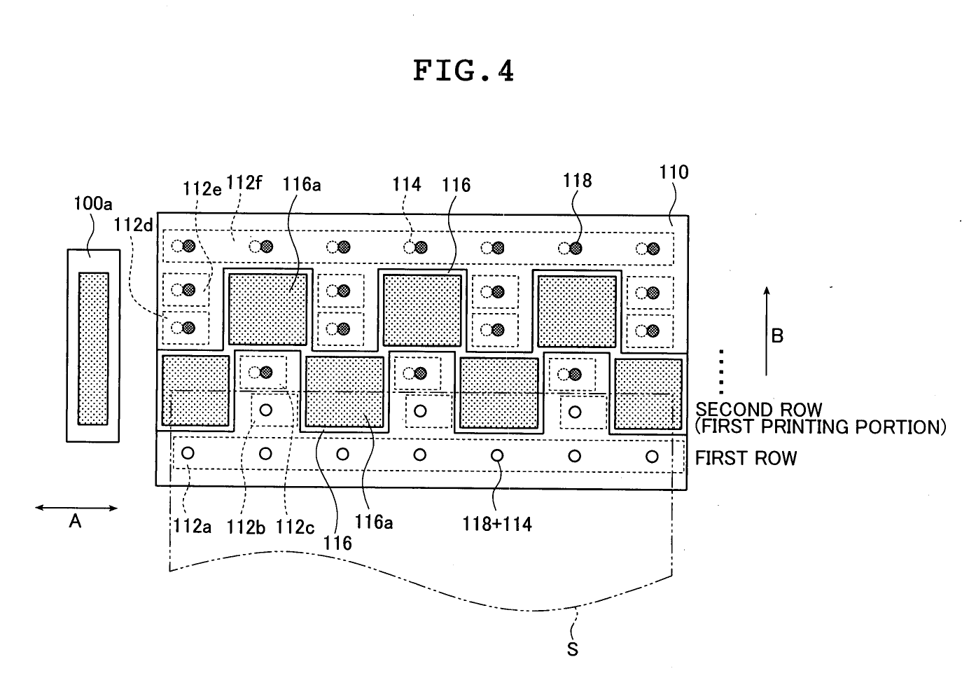

FIG. 4 shows a status in which the recording sheet S that has been transported from the lower side of the drawing, reaches a position where the recording sheet S covers the suction holes 118 in the first and second rows on the platen 110.

In practice, when the recording sheet S is transported from the lower side of the drawing, the suction holes 118 in the first row (the lowest row in FIG. 4) are first covered by the recording sheet S. Therefore, at a timing just before the suction holes 118 in the first row are covered, the airflow shielding plate 112a which is located in the first row is moved in the right direction in the drawing (this status is illustrated in FIG. 4) to allow the suction holes 118 in this row to open to suck the recording sheet S. Accordingly, the leading edge of the recording sheet S is sucked toward the platen 110.

Then the recording sheet S is further transported to a position (the first printing portion) where the recording sheet S covers the suction holes 118 in the second row from the bottom. In this case also, at a timing just before the suction holes 118 in the second row are covered, the airflow shielding plate 112b which is located in the second row (the first printing portion) is moved in the right direction in the drawing (this status is illustrated in FIG. 4) to allow the suction. holes 118 in this row to open to suck the recording sheet S. In FIG. 4, the two rows of suction holes in the above described status are represented by solid line open circles (◯). Accordingly, the position, in which the leading ledge of the recording sheet S is sucked, advances nearer to the center of the platen 110.

When the recording sheet S reaches the position shown in FIG. 4, the recording head 100a starts borderless printing onto the recording sheet S in the region including the leading edge, from the left side to the right side in the drawing, by ejecting ink from ejecting nozzles existing in a part (substantially the lowest one quarter in FIG. 4) of the recording head 100a. In borderless printing, it is necessary to print only the region in which the ink receiver 116 is arranged. Therefore, for the second row, for instance, after printing is started from the left side, printing is interrupted and restarted, and such a cycle of interruption and restarting is repeated other two times.

It is needless to say that the portion (region) where printing is not performed in the above printing process will be printed at a time when the recording sheet S is further transported by other two rows of the suction holes 118 and reaches the third printing portion, and the region to be printed reaches a position where the ink receiver 116 is provided. For controlling the recording head 100a in such a manner, the method described in detail in JP 2004-106432A may be used.

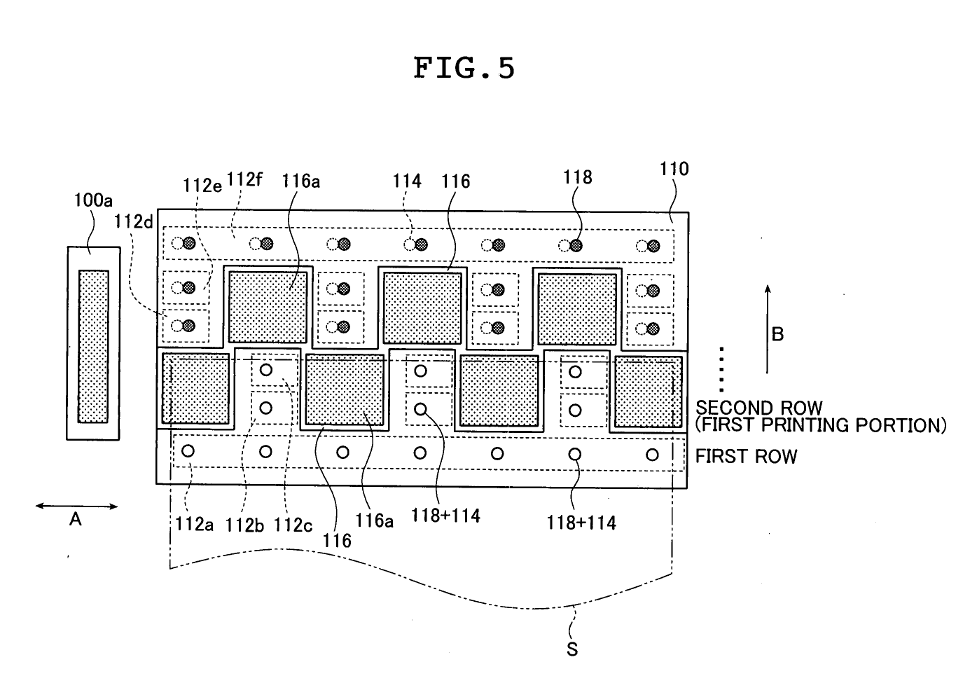

FIG. 5 shows a status in which the recording sheet S that has been further transported reaches a position (the second printing portion) where the recording sheet S covers the suction holes 118 in the third row from the bottom. In this status, at a timing just before the suction holes 118 in the third row are covered, the airflow shielding plate 112c which is located in the third row is moved in the right direction (this status is illustrated in FIG. 4) to allow the suction holes 118 in this row to open to suck the recording sheet S. Accordingly, the position, at which the leading ledge of the recording sheet S is sucked, advances nearer to the center of the platen 110.

In the status shown in FIG. 5, borderless printing is performed onto a region subsequent to (upstream side in the transport direction of the recording sheet S) the region printed in the status shown in FIG. 4, in the same manner as described in conjunction with FIG. 4.

Subsequently, the steps of transporting the recording sheet S, controlling the movement of the airflow shielding plate 112a-112f which move in conjunction with the transport of the recording sheet S, and printing are repeated sequentially, in the same manner. The printing on the leading edge of the recording sheet S ends when the recording sheet S has been transported (intermittently transported) four times after the recording sheet S reaches the position in which the recording sheet S covers the suction holes 118 in the second row in the drawing.

Then, printing is performed onto the recording sheet S from a middle portion to the leading edge, in the same manner as described above.

It is needless to say that while printing is performed on the middle portion, all of the airflow shielding plates 112a-112f allow the suction holes 118 to open to suck the recording sheet S.

Next, description will be given on the operation to be performed after the recording sheet S is further transported and its trailing edge reaches the platen 110.

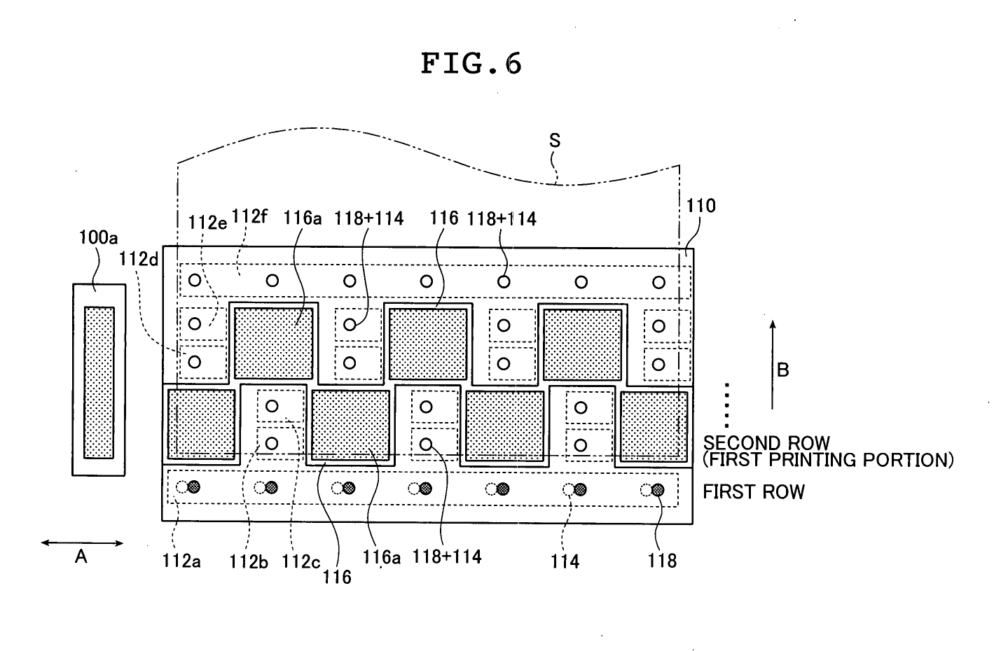

FIG. 6 illustrates a status in which the trailing edge of the recording sheet S reaches the platen 110, and the recording sheet S releases the covering of the suction holes 118 in the first row. At a timing just before the covering is released, the airflow shielding plate 112a located in the first row is moved in the left (FIG. 6 shows this situation) to close the suction holes 118 in this row.

Then, when the recording sheet S is further transported, and the covering of the suction holes 118 in the second row is released by the trailing edge, the airflow shielding plate 112b located in the second row is moved in the left to close the suction holes 118 in this row.

The recording head 100a, then performs final borderless printing onto the recording sheet S in the region including the trailing edge, from the left side to the right side in the drawing, by ejecting ink from ejecting nozzles existing in the entire region.

In the subsequent printing process, each time when the recording sheet S is transported, an applicable airflow shielding plate 112 is moved in the left to close the suction holes 118 in the applicable row, so that the airflow which may affect the ejection status of the ink droplets toward the recording sheet can be suppressed, and the remaining regions are printed.

In this way, at a time when the printing completes, all the suction holes 118 on the platen 110 are in closed status.

According to the above embodiment, an inkjet printer capable of preventing image quality from being degraded in the leading and trailing edges of the recording sheet S, even if borderless printing is performed onto a cut sheet type recording sheet S, is provided.

It should be noted that, in the inkjet printer shown in the above embodiment, due to configuration of the ink receivers 116, not all the ejection nozzles of the recording head 100a are used.

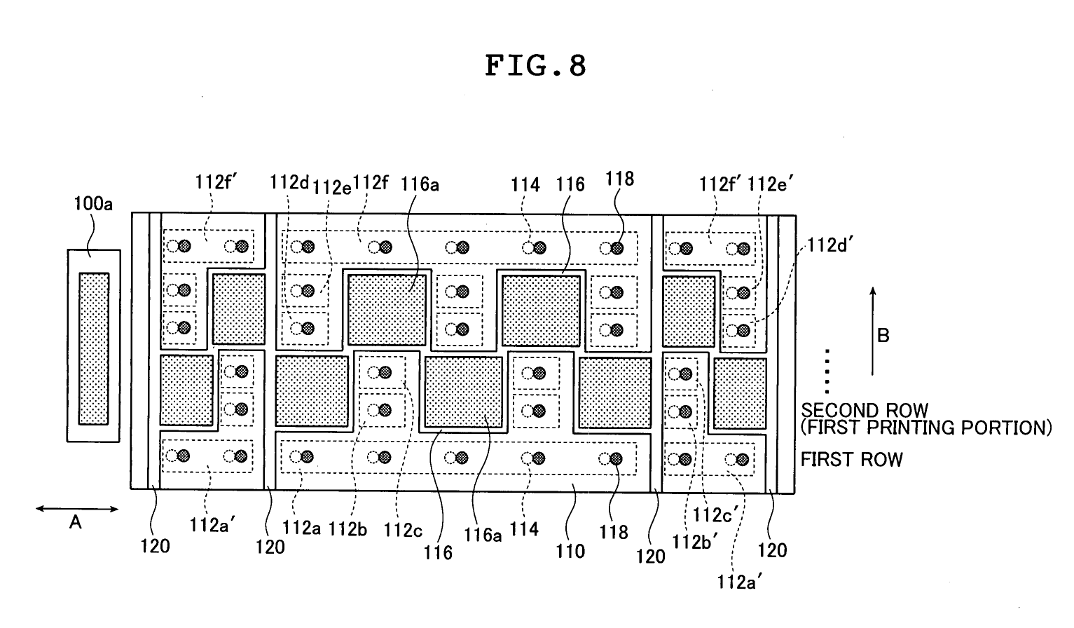

In order to improve the speed in printing the middle portion (other than the leading and trailing edges) of the recording sheet S, another embodiment is shown in FIG. 8, in which two pairs of long ink receivers 120 are provided along the recording sheet transport direction corresponding to the width of the recording sheet to receive ink droplets landed outside the both edges of the recording sheet S. Combination of the plurality of staggered ink receivers 116 and the pair of long ink receivers 120 as shown in FIG. 8, i.e., in such a manner that the respective ink receivers 120 provided at a location corresponding to the width of the recording sheet overlaps at least either of the upstream side or the downstream side, or both of the plurality of staggered ink receivers 116, enables all of the ejection nozzles of the recording head 100a to be utilized, thus achieving higher printing. Here, the (pairs of) long ink receivers 120, four (two pairs of) long ink receivers 120 in the drawing, provided in parallel with each other in the transport direction of the recording sheet S for an ink receiving section in the transport direction, while a plurality of ink receivers 116, seven ink receivers 116 in the drawing, arranged in a staggered manner in the width direction of the recording sheet S form the ink receiving section in the width direction as described above. The ink receiving section in the width direction and the ink receiving section in the transport direction together form the entire ink receiving section.

If providing ink receivers 120 in the recording sheet transport direction as shown in FIG. 8, rows of the suction holes 118 (first to sixth rows of suction holes) in the width direction are separated by the four ink receivers 120. In the drawing, an area separated by two ink receivers 120 on the inner side contains the airflow shielding plates 112a, 112b, 112c, 112d, 112e, and 112f, which are collectively moved by a row of the suction holes 118 in the respective width direction to thereby open and close the suction holes 118 by the row (the first to sixth rows of the suction holes) in the respective width direction. In addition, in the drawing, both side areas separated by the ink receiver 120 on the inner side and the ink receiver 120 on the outer side contain the airflow shielding plates 112a′, 112b′, 112c′, 112d′, 112e′, and 112f′, which are also collectively moved by a row of the suction holes 118 in the respective width direction to thereby open and close the suction holes 118 by the row (the first to sixth rows of the suction holes) in the respective width direction.

Since in the embodiment shown in FIG. 8, recording sheets S each having a different width are center-registered when transporting the recording sheets S for auxiliary scanning, a plurality of pairs of ink receivers 120 are provided symmetrically with respect to the center line along the transport direction. However, the present invention is not particularly limited to this embodiment. In the present invention, recording sheets S each having a different width may be side-registered when transporting, where an ink receiver 120 is provided for one side of the recording sheet S to be commonly used for the recording sheet S having a different width and another ink receiver 120 is provided for the other side of the recording sheet S in accordance with the recording sheet width.

The image recording apparatus of the present invention has been described heretofore in detail. However, the prevent invention is not limited to the embodiments described above and it is of course possible to make various modifications and changes without departing from the gist of the present invention.

For instance, in order to prevent deterioration of image quality of the recorded image due to air flow for sucking the recording sheet S, the embodiments described above perform opening/closing of a plurality of suction holes 118 provided on the upper surface of the suction printing plate 102b (platen 110) in sync with transportation of the recording sheet S during drawing an image onto the recording sheet S with the recording head 110a. In addition to the constitution, the image recording apparatus of the present invention may of course perform opening/closing of a plurality of suction holes 118 provided on upper surfaces of a front suction transport section 102a and/or a rear suction transport section 102c arranged in front of and in the rear of the suction printing plate 102b illustrated in FIG. 2. during drawing an image onto the recording sheet S with the recording head 110a.

What is claimed is:

1. An inkjet printer having a suction mechanism for sucking a recording medium in a printing table comprising:
opening/closing means for closing a part of a plurality of suction holes provided in said suction mechanism,
wherein, when a leading or trailing edge of said recording medium in a transport direction is printed, said opening/closing means closes a part of said plurality of suction holes that are provided in a vicinity of said leading or trailing edge of said recording medium and are not covered with said recording medium.

2. The inkjet printer according to claim 1, further comprising:
a width directional ink receiving section having staggered arrangement structure in which width directional ink receivers are arranged in a staggered manner in a width direction perpendicular to said transport direction of said recording medium,
wherein said opening/closing means controls opening/closing of said suction holes in a unit of each row in said width direction.

3. The inkjet printer according to claim 2, further comprising:
a transport directional ink receiving section having transport directional ink receivers that overlap with said width directional ink receivers arranged in the staggered manner in at least one of an upstream side and a downstream side and that are arranged in parallel along said transport direction of said recording medium,
wherein said opening/closing means controls opening/closing of said suction holes in a unit of each row in said width direction separated by said transport directional ink receivers.

4. The inkjet printer according to claim 3, wherein said transport directional ink receiving section has said transport directional ink receivers that correspond to a width of said recording medium and that are disposed along said transport direction of said recording medium.

5. The inkjet printer according to claim 1, further comprising:
transport directional ink receivers that correspond to a width of said recording medium and are disposed in parallel along said transport direction of said recording medium.

6. An inkjet printer, comprising:
a printing table including a suction mechanism having plural suction holes for sucking a recording medium to attach said recording medium on a surface of said printing table;
an inkjet recording head disposed on an opposite side of said printing table, for ejecting ink droplets on said recording medium attached on said surface of said printing table to print an image on said recording medium; and
opening/closing means for opening or closing each of said plural suction holes provided on said suction mechanism,
wherein, when a leading and/or trailing edge of said recording medium in a transport direction of said recording medium is printed, said opening/closing means opens said plural suction holes covered with said recording medium to suck said recording medium to attach said recording medium on said surface of said printing table and closes a part of said plural suction holes that are provided in a vicinity of said leading and/or trailing edge of said recording medium and are not covered with said recording medium.

7. The inkjet printer according to claim 6, further comprising:
an ink receiving section that receives said ink droplets ejected from said inkjet recording head and landed outside an edge of said recording medium.

8. The inkjet printer according to claim 7, wherein
said ink receiving section comprises a first ink receiving section in a width direction having staggered arrangement structure in which first ink receivers in said width direction that receive said ink droplets landed outside said leading and/or trailing edge of said recording medium in said transport direction are arranged in a staggered manner in said width direction perpendicular to said transport direction of said recording medium,
said suction mechanism comprises in said transport direction plural rows of said suction holes that are aligned in said width direction, and
said opening/closing means controls opening/closing of said suction holes of said suction mechanism in each row of said suction holes in said width direction.

9. The inkjet printer according to claim 8, wherein
said ink receiving section comprises a second ink receiving section in said transport direction having second ink receivers in said transport direction that overlap with said first ink receivers arranged in the staggered manner in at least one of an upstream side and a downstream side, that are arranged in parallel along said transport direction and that receive said ink droplets landed outside a side edge of said recording medium in said width direction,
said plural rows of said suction holes of said suction mechanism in said width direction are separated by said second ink receivers in said transport direction, and
said opening/closing means controls opening/closing of said suction holes in each row of said suction holes in said width direction separated by said second ink receivers.

10. The inkjet printer according to claim 9, wherein
said second ink receiving section in said transport direction comprises said second ink receivers in said transport direction that correspond to a width of said recording medium and are disposed along said transport direction of said recording medium.

11. The inkjet printer according to claim 8, wherein
said ink receiving section comprises a second ink receiving section in said transport direction having at least one pair of second ink receivers in said transport direction that overlap with said first ink receivers arranged in the staggered manner in at least one of an upstream side and a downstream side, that are arranged in parallel along said transport direction and that receives said ink droplets landed outside both side edges of
said recording medium in said width direction, said plural rows of said suction holes of said suction mechanism in said width direction are separated by said second ink receivers in said transport direction, and
said opening/closing means controls opening/closing of said suction holes in each row of said suction holes in said width direction separated by adjacent two second ink receivers.

12. The inkjet printer according to claim 11, wherein
said second ink receiving section in said transport direction comprises plural pairs of said second ink receivers in said transport direction that correspond to plural widths of recording media and are disposed along said transport direction of said recording medium.
